(19) United States
(12) Patent Application Publication
(10) Pub. No.: US 2017/0109780 A1
(43) Pub. Date: Apr. 20, 2017

(54) SYSTEMS, APPARATUSES AND METHODS FOR USING VIRTUAL KEYBOARDS

(71) Applicant: OverSignal, LLC, Stanwood, WA (US)

(72) Inventors: Brian Moore, Stanwood, WA (US); Keith Senator, Covington, GA (US); Matthew McCutchen, Shoreline, WA (US)

(21) Appl. No.: 15/316,095

(22) PCT Filed: Jun. 4, 2015
(86) PCT No.: PCT/US15/34300

§ 371 Date: Dec. 2, 2016

Related U.S. Application Data
(60) Provisional application No. 62/007,890, filed on Jun. 4, 2014.

(51) Int. Cl. G06Q 30/02; G06F 3/0488

(52) U.S. Cl. CPC G06Q 30/0244; G06F 3/04886; G06Q 30/0201; G06Q 30/0277; G06Q 30/0269; G06F 3/04883

(57) ABSTRACT

Methods and systems are disclosed for interacting with advertisements on a virtual keyboard. A user can manipulate the advertisement based on performing one or more types of gestures or key presses on or near the virtual keys. One type of gesture triggers an interaction with the advertisement and another type of gesture or key press performs a standard keyboard function. The virtual keyboard can be used to collect data from the user and/or device displaying the keyboard.

### CROSS-REFERENCE TO RELATED APPLICATION(S)

This application claims priority to U.S. Provisional Application No. 62/007,890, filed Jun. 4, 2014 and entitled “SYSTEM AND METHODS FOR USING VIRTUAL KEYBOARDS,” the contents of which are incorporated by reference in its entirety. Additionally, this application claims priority to U.S. Provisional Patent Application No. 61/748,721, filed on Jan. 3, 2013, and entitled, “SYSTEMS AND METHODS FOR ADVERTISING,” the contents of which are incorporated by reference in its entirety.

### BACKGROUND

Online advertising generates a large amount of online traffic and revenue. Online advertisements are a nearly ubiquitous feature of our online experience because online advertisers typically advertise goods and services on or with websites, mobile apps, video games, set-top boxes, streaming media, and so on. In many cases, advertisements may be targeted to users based on, for example, demographic information, online activities, search activities (e.g., search queries), online shopping activities, and so on. Online advertisements may take the form of one or more pop-up advertisements, pop-under advertisements, banner advertisements, audio advertisements, video advertisements, animated gifs, and so on. Desktop computers, which typically include computer monitors, can offer relatively vast amounts of space for displaying or presenting advertisements, Handheld devices, however, typically provide a limited amount of visual display space or real estate for users to view or interact with, necessarily making online advertisements either annoyingly large, or small and difficult to interact with. When the visual space available for online advertisements is limited, online advertisements may interfere with a user's online experience. For example, a pop-up advertisement may be displayed in such a way that it completely takes over the viewable area of the user's device. As another example, the user may accidentally click on or select the advertisement if the advertisement is displayed over or near a feature of a webpage or application with which the user interacts.

### SUMMARY

At least some embodiments are directed to a computer-implemented methods, devices and systems (“the technology” or “described technology”) of processing data entered via a virtual keyboard or other input device. The data can be analyzed and processed to perform targeted advertising. In some embodiments, the targeted advertising is based, at least in part, on data aggregated from virtual keyboard input, navigating one or more online sources via the virtual keyboard, and/or other usage of an electronic device (e.g., mobile telephone, tablet, smart phone, laptop, TV) that displays the virtual keyboard.

In some embodiments, a virtual keyboard can be used to collect data that is associated with one or more user identifiers. The user identifier can be a user's password, device identifier, biometric identifier, or other identifier suitable for indicating a particular user/device. In one embodiment, the virtual keyboard can identify a user based on, for example, user login information. For example, a virtual keyboard program can communicate with the operating system or other software that identifies the user based on a login password, biometric data/information, etc. In other embodiments, the virtual keyboard program may not be linked to particular users. For example, the virtual keyboard program can collect any desired data inputted into the device.

Older techniques may store user input data as silos of information available only to respective Apps, software, programs, etc. that received that data via a keyboard. For example, a search query entered into a browser is not automatically available to, e.g., a game, blog, SMS text, etc. resulting in low fidelity information about the user. In various embodiments, the described technology captures data via the virtual keyboard and the data made available to the technology and/or to a remote system while the data is actively being entered by the user, via the virtual keyboard, and irrespective and independently of the software, server, and/or App, etc. intended by the user to receive the data. The technology does not need to wait to act on the data (e.g., use the data for advertisements, marketing, research, governmental use, etc.) until all of the user's input data is entered or submitted via the virtual keyboard to, e.g., a website and/or mobile App. The technology can act upon each captured data (e.g., a swipe, text, a selection, etc.) in real-time for, e.g., determining one or more advertisement targeted at the user. As the user enters additional data (e.g., writes a word, sentence, or navigates a webpage, etc.) higher resolution information (e.g., metadata) can be determined from the raw data and used to determine higher fidelity advertisements or to sell on the market. The virtual keyboard is “on top” of (i.e., an overlay to) the software, programs, and/or Apps, etc. that receive the data from the user. In some embodiments, data is captured across multiple, separate, and/or different Apps, programs, software, etc. For example, as the user enters data in first App (e.g., Twitter®) data is captured by the virtual keyboard and, if the user switches to a second App (e.g., Facebook® or other software, program, etc.), the virtual keyboard will capture any entered data for the second App as well as a third, fourth, fifth and next App, software, program, search, message, etc. Collecting data across multiple platforms, in various embodiments, provides higher fidelity data than data captured by an individual platform.

Collected data may be processed and, in some embodiments, may be combined with other data. Data processing may include, without limitation, randomizing, separating, storing, warehousing, segregating, parsing, classifying, prioritizing, filtering, and/or otherwise manipulating data. The unprocessed or processed data can be combined with other data and can be packaged and sold in various formats, including raw data, processed data (e.g., filtered/interpreted data packages), or the like. Additionally or alternatively, collected data can be utilized by third-party applications, including operating systems, websites, locally installed programs, or the like.

Data can be transferred from a local device with a virtual keyboard to servers, data storage facilities, and/or other storage sites. In one embodiment, the data is processed by the electronic device that displays the virtual keyboard. In other embodiments, the data is analyzed by servers that receive the information from the device. In yet other embodiments, the data is processed by a remote storage site. Data can be continuously or periodically archived locally or remotely. Advertisements can be ranked, dismissed, and otherwise processed based on user data (e.g., a user's input, preferences, etc.).

In some embodiments, the technology for displaying advertisements includes receiving one or more advertisements at an electronic device with a touchscreen. The touchscreen can display one or more input features used by the user. The data can be collected locally and/or remotely. For example, data can be collected by the electronic device to modify operation of the electronic device. Data can also be collected remotely by, for example, remote computers, server, data centers, or the like. In some embodiments, the user utilizes a virtual keyboard displayed by the touchscreen to input data. Advertisements, marketing, polling, searching, espionage and related strategies can be determined based, at least in part, on collected data. In one embodiment, both advertisements and operation of the virtual keyboard can be controlled by the collected data.

### BRIEF DESCRIPTION OF THE DRAWINGS

FIG. 1A is a block diagram illustrating an environment in which the disclosed techniques may operate.

FIG. 1B is a block diagram of a basic and suitable computer that may employ aspects of the described technology.

FIG. 2 is a block diagram showing some of the components incorporated in associated computing systems.

FIG. 3 is a display page representing two screenshots of a virtual keyboard.

FIG. 4 is a flow diagram illustrating the processing of a display virtual keyboard ad component.

FIG. 5 is a block diagram illustrating the processing of a user interaction component.

FIG. 6 is a block diagram illustrating the processing of a user interaction component.

### DETAILED DESCRIPTION

Technology for providing non-obtrusive techniques for presenting advertisements (e.g., an advertisement impression) to users of mobile devices, such as mobile telephones, tablets, smart phones, laptops, TVs, and other devices with limited display space. In some embodiments, the disclosed techniques display advertisements as part of or otherwise associated with a virtual keyboard displayed on the device. For example, a visual advertisement may be displayed as part of a spacebar or other key or keys of a virtual keyboard. In other words, the graphical representation of the spacebar (or another key or keys) may for example, be replaced by, blended (e.g., alpha compositing techniques) or otherwise modified with a graphical advertisement, such as a banner ad. Although the graphical representation of the visual spacebar is modified, the functionality of the spacebar may remain the same. For example, a user can continue to use the virtual keyboard and its associated keys to interact with the mobile device, (e.g., to type a message across the Internet, interact with an application (App), etc.) while the advertisement is display. In this manner, advertisements are presented in a less-intrusive or non-intrusive manner. Furthermore, user interactions with advertisements can be tracked across multiple websites or web access points, across multiple mobile device functions (e.g., mobile applications, email, text messaging, iMessaging, posts, searches, social network interactions), and across multiple devices.

In some embodiments, the disclosed techniques may allow a user to interact with a displayed advertisement using various gestures. For example, a user may be able to activate an advertisement displayed in place of or in addition to one or more keys of a virtual keyboard by performing a swipe gesture in a variety of directions, such as up, down, left or right. A swipe gesture, for example, can reduce the number unintentional “clicks” on or near the advertisement, thereby increasing the likelihood that activations of advertisements are intentional. By activating the advertisement, in some embodiments, a user is directed to one or more websites, applications, and/or files (e.g., media files, video files, or audio files) for or associated with, for example, the advertiser. Furthermore, the user may be able to perform other actions based on one or more swipe gestures in various directions, such as down or to the left. For example, in some embodiments, one or more swipes to the virtual keyboard can forward the advertisement to another user; save the advertisement; follow the associated advertiser on a social network site (e.g., TWITTER®); share the advertisement or associated advertiser (e.g., company) on a social networking site (e.g., FACEBOOK®, PINTEREST®, etc.); “like” (e.g., performing a binary-like approval or disapproval) the advertisement; and/or rate the advertisement. The inventors have found that rating an advertisement has several advantages over “liking” the advertisement. For example, “likes” can be arbitrary. You may “like” something because: a friend requested you to do so, you actually do like it, or for any number of reasons. Ratings offer a much more accurate picture of what a brand, product, or company means to a person. For example, ranking an advertisement, in some embodiments, allows the advertisement to be marked as irrelevant, offensive, and/or removed from future advertisements from a particular company or a particular type of advertisement.

In some embodiments, the disclosed techniques display advertisements at a mobile user device based on identifying one or more actions to associate with virtual key(s) proximate to the advertisement. The disclosed technique can detect and react to a selection of virtual key(s) based on one or more selection types. For example, a first selection type (e.g., a user gesture, eye movement, etc.) initiates (i.e., triggers) a first action for interacting with advertisement(s) (e.g., scroll through advertisements, open an advertisement in a new window, open a website, buy a good/service, etc.) and a second action (e.g., a non-gesture-based action, such as pressing a virtual ‘A’ key) initiates display of a representation of a symbol, character, or alphanumeric value associated with the selected virtual key (e.g., an ‘%’, ‘A, ‘5’, etc.), for example. In some embodiments, a first gesture (e.g., a swipe) and a second, different gesture (e.g., an ‘L’-shaped gesture) performed proximate to the same advertisement initiate different actions. For example, a swipe across an advertisement may cause a display of more information regarding about that advertisement and a ‘L’-shaped gesture performed proximate to that same advertisement may minimize the advertisement to a portion of a display, save the advertisement for later, or send the advertisement to a friend, etc.

In some embodiments, the virtual keyboard is projected from a laser, LED, infrared component, or other transfer medium to form a 2D or pseudo 3D image of the virtual keyboard. For example, the disclosed techniques can cause a mobile device to focus light in the shape of a keyboard onto a surface, such as a table. All or some of techniques mentioned above and further discussed below (e.g., user based gestures to interact with advertisements) equally apply to projected virtual keyboards.

In some embodiments, the virtual keyboard provides feedback, such as a sound, light, one or more signals to an external device, or haptic feedback. For example, a virtual key (e.g., a space bar) of the virtual keyboard may display a picture of a Chevy Camaro. When the advertisement is touched, haptic feedback (e.g. a force, motion, and/or vibration) may provide, via one or more of the virtual keys, the feeling that the Camaro's engine is revving, for example. Feedback, in some embodiments, is incorporated in situations where two or more users are in the same location experiencing advertisements related to a television program or “app” that they were participating in. For example, feedback can indicate that time is running out to input of an answer via the virtual keyboard.

In some embodiments, the described techniques aggregate information from different sources (e.g., remote networks, websites, advertisement services, a user profile, real-time virtual keyboard input, user history, cached data, biometric data, etc.) into descriptive metadata (i.e., data about data) that, in various embodiments, is used to control (e.g., increase) the accuracy and efficiency in targeting advertisements to a user. Information can include, without limitation, gender information, academic information, research interests (e.g., scientific, political, etc.), sports interest, manufacturing information, historic and/or real-time location information, demographic information, political preferences, and other information that can be used to refine and tailor a new advertisement to target the user. When the user uses the virtual keyboard, the electronic device can obtain biometric data (e.g., via an eye scan, a finger scan, etc.) to identify the user.

When the virtual keyboard is used to fill-in a textbox on a website, navigate an online/local website, make a phone call, search for a restaurant, enter a new contact, play a game, open and/or interact with an App (e.g., software running on a mobile device, such as a phone or tablet), and/or compose a message, etc., that information can be used by the described technology to generate metadata that combines the disparate information into a new, synthesized format. Metadata is processed (e.g., aggregated, deduplicated, categorized, and rationalized into new information) by the described technology. Metadata, or portions of metadata, can be combined with other metadata, sold to third parties, and/or stored and appended to. For example, the described technology can build metadata by gathering input received at the virtual keyboard for: interacting with an App (e.g., Yelp), entering text into a social website, forming a query for a movie that plays next Saturday night, entering data to order food, and ordering flowers online. In this example, the described technology can generate metadata that describes a profile of a male between the ages of 18-30 who is going on a date on Saturday. The metadata can be sold to one or more advertisers. Advertisements sent for display at the virtual keyboard (or at another location) can be targeted to that user and/or the user profile (e.g., romantic restaurants with available tables on Saturday that are near a theater). Advantageously, information (e.g., metadata, raw user data, etc.) generated and/or accessed using the virtual keyboard can be more accurate, valuable, and useful than data captured via various “silos” including, for example, search, social networks, messaging, email, or applications.

The inventors have contemplated other techniques to refine and target advertisements, such as receiving an indication that an advertisement was selected at and/or associated with activity at a separate, local and/or remote device (e.g., a separate virtual keyboard operated by the same or a different user), an interactive TV device, smart glasses, smart watch, or other device; refining the information based on target data from an advertiser; and/or refining the information based on one or more user preferences, user history, or tracking data. The collected information (e.g., the metadata) can be provided to third parties. For example, the information can be monitored by and/or sold to third parties to more efficiently track and target advertisements for display at the virtual keyboard. In some embodiments, the data from different users can be aggregated to determine advertising strategies for groups of users. Users can be reclassified any point time to perform group targeted advertising. Additionally or alternatively, the virtual keyboard can collect data across a wide range of different programs to ensure that a large amount of data is collected to accurately analyze the user.

In some embodiments, the data is collected before and/or substantially simultaneously while the data is entered, via the keyboard (e.g., based on one or more user inputs, such as a key press, touch, and/or gesture), into a query, search field, email, text message, instant message, text box, and/or other input configured to receive data. Interactive, real-time advertisement feedback is based, in one or more embodiments, on dynamically receiving and operating on portions of incomplete user input. For example, while the user is actively inputting data into the virtual keyboard (e.g., via one or more key presses and/or gestures) each user input is separately received by the described technology. Substantially simultaneous with each received user input (i.e., as each key and/or gesture is being entered at the virtual keyboard), the described technology can generate probabilistic determinations of the user's desired final word, phrase, and/or sentence. The probabilistic determinations are used to create data (e.g., metadata) that can be used to generate, receive, and/or sell advertisements based on the expected resultant input. In various embodiments, advertisements are displayed in relative real-time while the user is entering the input. For example, while the user is swiping one or more gestures and/or entering text relating to coffee, data is dynamically used to locally or remotely trigger advertisements for nearby and/or previously visited coffee shops. The advertisements, in one or more embodiments, are dynamically and substantially automatically displayed at the virtual keyboard prior to the user completing the final word, phrase, and/or sentence. Using the virtual keyboard, the user can swipe (e.g., make a motion up or down) to review, accept a coupon for, remove, find directions to, save, and/or query additional information for one or more coffee-related advertisements.

The following description provides specific details for a thorough understanding and enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments.

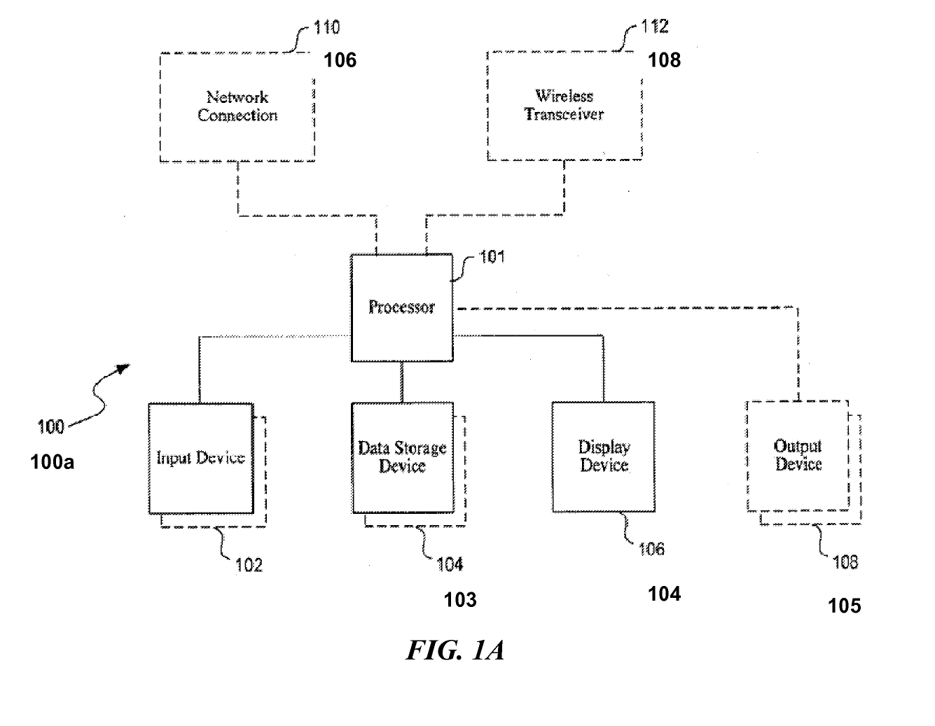

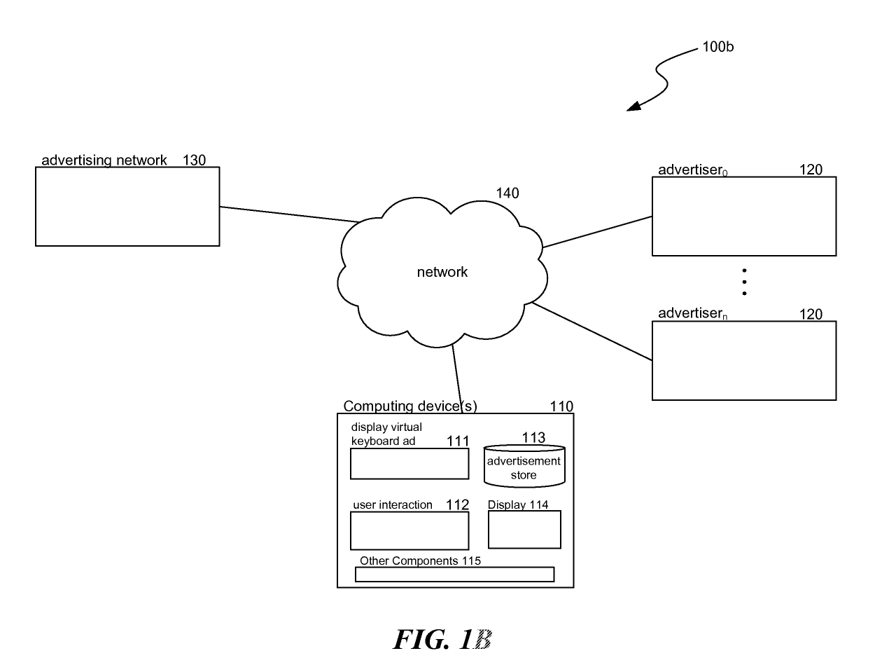

Certain details are set forth in the following description and in FIGS. 1-12 to provide a thorough understanding of various embodiments of the disclosure. Other well-known structures and systems often associated with private placement investments have not been shown or described in detail below to avoid unnecessarily obscuring the descriptions of the various embodiments of the disclosure. Additionally, a person of ordinary skill in the relevant art will understand that the disclosure may have additional embodiments that may be practiced without several of the details described below. In other instances, those of ordinary skill in the relevant art will appreciate that the technology described can include additional details without departing from the spirit or scope of the disclosed embodiments.

Many of the details, dimensions, functions and other features shown and described in conjunction with the Figures are merely illustrative of particular embodiments of the disclosure. Accordingly, other embodiments can have other details, dimensions, functions and features without departing from the spirit or scope of the present disclosure. In addition, those of ordinary skill in the art will appreciate that further embodiments of the disclosure can be practiced without several of the details described below.

The terminology used in the description presented below is intended to be interpreted in its broadest reasonable manner, even though it is being used in conjunction with a detailed description of certain specific embodiments of the described technology. Certain terms may even be emphasized below; however, any terminology intended to be interpreted in any restricted manner will be overtly and specifically defined as such in this Detailed Description section.

The techniques introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

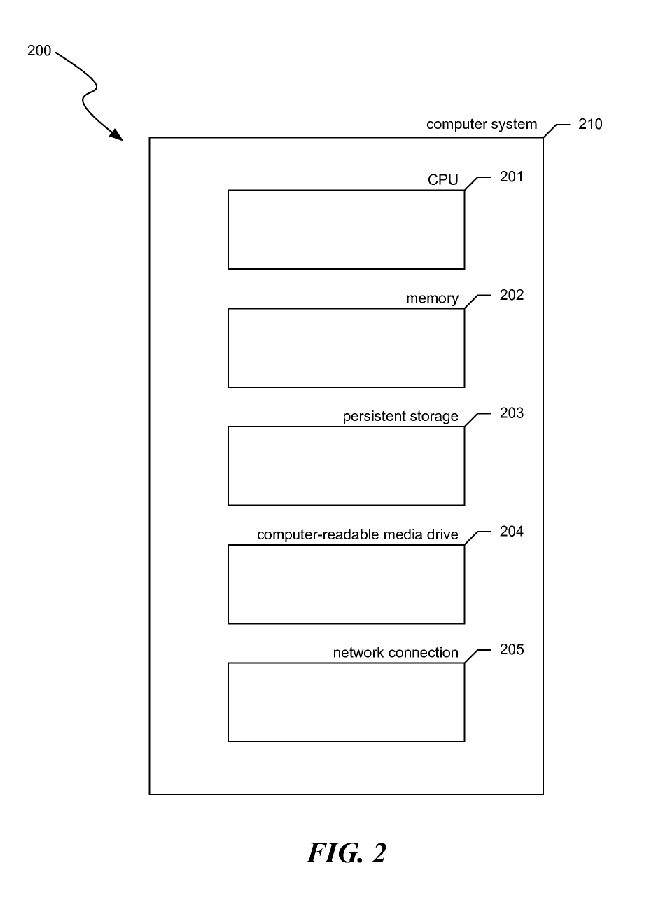

FIGS. 1-2 and the following discussion provide a brief, general description of a suitable computing environment in which aspects of the described technology can be implemented. Although not required, aspects of the described technology may be described herein in the general context of computer-executable instructions, such as routines executed by a general- or special-purpose data processing device (e.g., a server or client computer). Aspects of the described technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the described technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (packet switched, circuit switched, or other scheme).

The described technology can also be practiced in distributed computing environments where tasks or modules are performed by remote processing devices, which are linked through a communications network, such as a Local Area Network (LAN), Wide Area Network (WAN), or the Internet. In a distributed computing environment, program modules or subroutines may be located in both local and remote memory storage devices. Those skilled in the relevant art will recognize that portions of the described technology may reside on a server computer, while corresponding portions reside on a client computer (e.g., PC, mobile computer, tablet, or smart phone). Data structures and transmission of data particular to aspects of the described technology are also encompassed within the scope of the described technology.

Portions of the described technology can be practiced on and/or distributed between one or more network appliances, A network appliance is a stand-alone device connected to a network and can be configured to communicate with another network appliance, server, and/or other computing device.

Referring to FIG. 1A and the following discussion provide a brief, general description of a suitable computing environment in which aspects of the described technology can be implemented. Although not required, aspects of the described technology may be described herein in the general context of computer-executable instructions, such as routines executed by a general- or special-purpose data processing device (e.g., a server or client computer). Aspects of the described technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the described technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (packet switched, circuit switched, or other scheme).

The described technology can also be practiced in distributed computing environments where tasks or modules are performed by remote processing devices, which are linked through a communications network, such as a Local Area Network (LAN), Wide Area Network (WAN), or the Internet. In a distributed computing environment, program modules or subroutines may be located in both local and remote memory storage devices. Those skilled in the relevant art will recognize that portions of the described technology may reside on a server computer, while corresponding portions reside on a client computer (e.g., PC, mobile computer, tablet, or smart phone). Data structures and transmission of data particular to aspects of the described technology are also encompassed within the scope of the described technology.

Portions of the described technology can be practiced on and/or distributed between one or more network appliances. A network appliance is a stand-alone device connected to a network and can be configured to communicate with another network appliance, server, and/or other computing device.

Referring to FIG. 1A, the described technology employs a computer 100a, such as a personal computer or workstation, having one or more processors 101 coupled to one or more user input devices 102 and data storage devices 103. The computer 100a is also coupled to at least one output device such as a display device 104 and one or more optional additional output devices 105 (e.g., printer, plotter, speakers, tactile or olfactory output devices, etc.). The computer 100a may be coupled to external computers, such as via an optional network connection 106, a wireless transceiver 108, or both.

The input devices 102 may include a keyboard, a pointing device such as a mouse, and described technology for receiving human voice, touch, and/or sight (e.g., a microphone, a touch screen, and/or smart glasses). Other input devices are possible such as a joystick, pen, game pad, scanner, digital camera, video camera, and the like. The data storage devices 103 may include any type of computer-readable media that can store data accessible by the computer 100a, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet (not shown in FIG. 1).

FIG. 1B is a block diagram illustrating a computing environment 100b in which the disclosed techniques may operate in some embodiments. In this example, computing environment 100b includes one or more computing device(s) 110, advertisers 120, advertising network 130, and network 140. User computing environment 110 includes, in some embodiments, display virtual keyboard ad component 111, user interaction component 112, and advertisement store 113. Display virtual keyboard advertisement component 111 can be invoked to display an advertisement on or as part of a virtual keyboard. User interaction component 112 is invoked to process user interactions with an advertisement displayed on or as part of a virtual keyboard. Advertisement store 113 stores advertisements and associated information (e.g., number of times an ad is displayed, rate of display, time of day information for the advertisement, timeout duration, expiration date/time) received from advertisers 120, advertising network 130, etc. Advertisers 120 can represent companies or other entities that generate advertisements. Advertising network 130 can be a company or entity that targets and distributes advertisements to users on behalf of advertisers based on, for example, geographic area (e.g., city location, country, etc.), time, user data, demographic information, user preferences, and so on. In other embodiments, the advertising network 130 can be operated by a manufacture of the user computing device(s) 110 or a distributor of the user computing device 110. Computing device(s) 110, advertisers 120, and advertising network 130 are connected and may communicate via network 140.

The computing device(s) on which the disclosed techniques may be implemented can include a screen (e.g., a touch screen), a central processing unit, memory, input devices (e.g., keyboards, virtual keyboards, touchscreens, and pointing devices), output devices (e.g., display devices) 114, storage devices (e.g., disk drives), and various other software and/or hardware components 115. The memory and storage devices are computer-readable storage media that may be encoded with computer-executable instructions that implement the technology, which means a computer-readable storage medium that stores the instructions. In addition, the instructions, data structures, and message structures may be transmitted via a computer-readable transmission medium, such as a signal on a communications link. Thus, “computer-readable media” includes both computer-readable storage media for storing information and computer-readable transmission media for transmitting information. Additionally, data used by the disclosed techniques may be encrypted. Various communications links may be used, such as the Internet, a local area network, a wide area network, a point-to-point dial-up connection, a cell phone network, wireless networks, and so on.

FIG. 2 is a block diagram 200 showing some of the components 201-205 incorporated in associated computing system(s) 210 (e.g. advertisement network 130, advertisers 120, and/or user computing device(s) 110, etc.) in some embodiment. Computer system 210 comprises one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable storage medium; and a network connection 205 for connecting the computer system 210 to other computer systems, such as via the Internet. While computer systems 210 configured as described above are suitable to support the operation of the disclosed technology, those skilled in the art will appreciate that the techniques may be implemented using devices of various types and configurations. Moreover, communications to and from the CPU 201 and on data buses and lines can be encrypted to protect against snooping of internal data.

The disclosed technology may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments, including cloud-based implementations.

Many embodiments of the technology described herein may take the form of computer-executable instructions, including routines executed by a programmable computer. Those skilled in the relevant art will appreciate that aspects of the technology can be practiced on computer systems other than those shown and described herein. Embodiments of the technology may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

The technology can also be practiced in distributed environments, where tasks or modules are performed by remote processing devices linked through a communications network. In a distributed computing environment, program modules or subroutines may be located in local and remote memory storage devices. Aspects of the technology described herein may be stored or distributed on computer-readable media, including magnetic or optically readable or removable computer disks. Furthermore, aspects of the technology may be distributed electronically over networks. Data structures and transmissions of data particular to aspects of the technology are also encompassed within the scope of the technology.

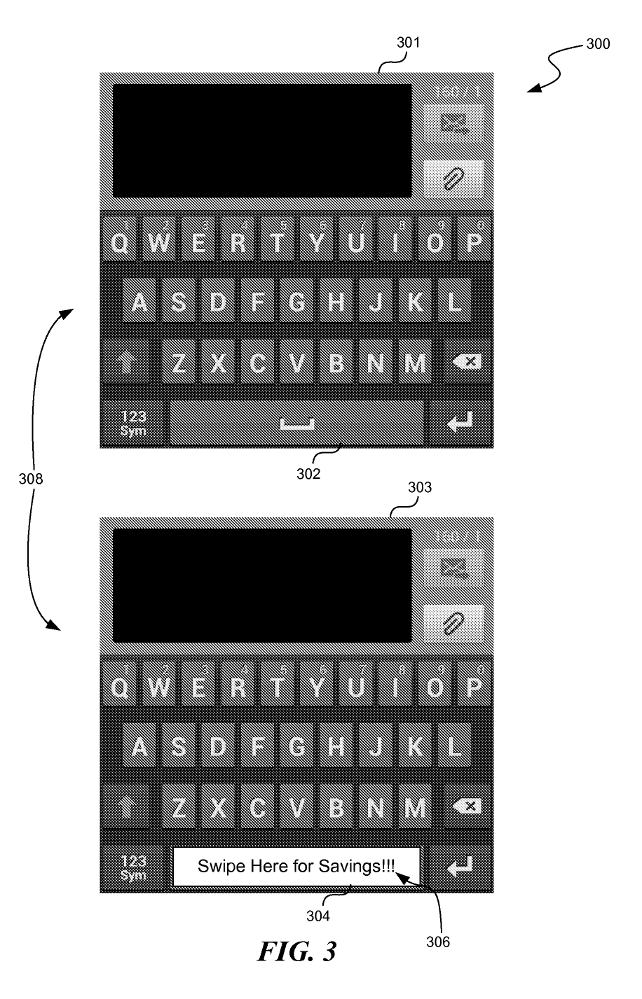

FIG. 3 is a depiction 300 of two example screenshots 301 and 303 of a virtual keyboard 308 on display 114, for example. For example, each of screenshots 301 and 303 include a virtual keyboard including a virtual spacebar 302-304. In screenshot 301, virtual spacebar 302 is displayed without an advertisement 306, The virtual spacebar 302 is configured to provide a relatively large area to display an advertisement 306. In screenshot 303, virtual spacebar 302 is displayed with an advertisement 306 inviting the user to “Swipe Here for Savings!!!” Although the advertisement 306 is displayed over virtual spacebar 302, a user may still enter space characters by pressing on or clicking the advertisement/spacebar. The user may interact with the advertisement by, for example, performing a swipe or other gesture at or near the advertisement. Although in this example the advertisement 306 is displayed in the vicinity of the virtual spacebar 302, one or more advertisements 304 may be displayed at any location on the virtual keyboard. For example, one advertisement (e.g., advertisement 304) may span the ‘W,’ ‘E,’ ‘R,’ ‘T,’ ‘S,’ ‘D,’ ‘F,’ ‘Z,’ ‘X,’ and ‘C,’ keys while another advertisement (not shown) spans the Y’ ‘U,’ ‘I,’ ‘O,’ ‘H,’ ‘J,’ ‘K,’ ‘B,’ ‘N,’ and ‘M’ keys. In this manner, the disclosed techniques can present advertisements to users without interfering with the user's ability to interact with the virtual keyboard 308 and associated computing device(s) 110. The virtual keyboards 308 can be part of an operating system (e.g., iOS, Android® Operating System, Blackberry operating system, or Microsoft Windows® operating system). In other embodiments, an application is installed to provide the virtual keyboard 308. The advertising functionality can be part of the virtual keyboard software or installed separately.

The user can use the virtual keyboard 308 to input data using key, e.g., presses, touches, thoughts (e.g., via a device measuring brain wave patterns), gestures, and/or other data input means, such as a voice command. The data can be collected before and/or substantially simultaneously while the data is entered. For example, user eye movement can be tracked using a camera and analyzed before or while data is inputted via the virtual keyboard 308. If the virtual keyboard 308 or input device is part of an wearable device, information about user's body (e.g., movement, heart rate, etc.), location, etc. can be collected. Different types of information and information from multiple devices, such as wearables (e.g., watches, eyewear, wearable activity tracker, etc.), smartphones, laptop computers, can be collected. Information from a wearable electronic device and a non-wearable device (e.g., a laptop computer) can be analyzed can collected dependently and independently.

Interactive, real-time advertisement feedback can be based on dynamically receiving and operating on portions of incomplete user input. For example, while the user is actively inputting data into the virtual keyboard (e.g., via one or more key presses and/or gestures) each user input is separately received by the described technology. Substantially simultaneous with each received user input (i.e., as each key and/or gesture is being entered at the virtual keyboard), the described technology can generate probabilistic determinations of the user's desired final word, phrase, intent, and/or sentence. The probabilistic determinations are used to create data (e.g., metadata) that can be used to generate, receive, and/or sell advertisements and for other uses, based on the expected resultant input. The probabilistic determinations can be determined based on information from multiple Apps, software, programs, etc. and across multiple devices associated with a user, groups of users, etc.

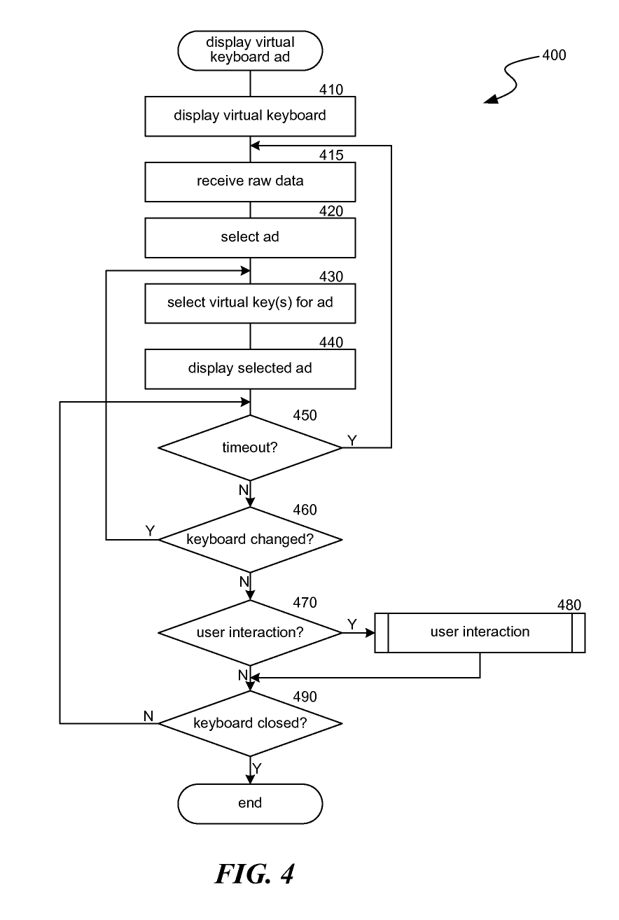

FIG. 4 is a flow diagram 400 illustrating the processing of a display virtual keyboard advertisement component 111 in some embodiments. In block 410, the display virtual keyboard advertisement component 111 (e.g. 308) displays a virtual keyboard 308 and, in block 415, receives raw data via virtual keyboard 308. In block 420, the display virtual keyboard advertisement component 111 selects an advertisement for display. Selection of the advertisement 308 may be based on one or more of the raw data from one or more uses, demographic information of one or more users, of the computing environment 100b, recent activity of one or more users, user preferences, and so on. For example, if a user is watching a television program on a smart TV and an advertisement or “product placement” for a particular product was recently displayed, the display virtual keyboard advertisement component 111 may select an advertisement 306 for the same or a similar product for display on another user computing device 110, such as the user's mobile telephone. In some embodiments, the display virtual keyboard advertisement component 111 may request an advertisement 306 from an advertising network 130 or advertiser 120. In block 430, the display virtual keyboard advertisement component 111 selects one or more virtual key(s) on the virtual keyboard 308 to display a selected ad. The display virtual keyboard advertisement component 111 may select virtual key(s) on the virtual keyboard 308 based on the shape of the advertisement, the virtual keyboard shape, virtual key layout, and availability of virtual keys that are currently displayed, user preferences, and so on. For example, if the selected advertisement (e.g., advertisement 306) is in the shape of a vertically long rectangle, the display virtual keyboard advertisement component 111 may select the virtual spacebar 302 for displaying advertisement 304. However, if the advertisement 306 is a square, the display virtual keyboard advertisement component 111 for example, may select virtual key(s) that approximate a square. Additionally and/or alternatively, a user and/or the display virtual keyboard advertisement component 111 may specify a preference for displaying advertisements (e.g., advertisement 306) on certain virtual keys or not displaying advertisements on certain virtual keys. For example, a user may specify that advertisements 306 should never be displayed on virtual keys other than the virtual spacebar 302. Accordingly, the display virtual keyboard advertisement component 111 will avoid displaying advertisements on those virtual keys. In some embodiments, advertisements 306 may include multiple representations (e.g., shapes, sizes, colors) so that the display virtual keyboard advertisement component 111 can more easily identify virtual keys capable of displaying the advertisement 306. In block 440, the display virtual keyboard advertisement component 111 displays a selected advertisement on or in combination with the selected virtual keys. For example, the display virtual keyboard advertisement component 111 may display the advertisement 306 over certain virtual keys or blend (e.g., alpha compositing techniques) the advertisement 306 with the image data associated with the selected key(s). As another example, the display virtual keyboard advertisement component 111 may display the advertisement 306 over the virtual keys but texture the advertisement so that the corresponding virtual keys appear as “bumps” under the advertisement 306. In decision block 450, if the displayed advertisement (e.g., advertisement 306) has timed out then the display virtual keyboard advertisement component 111 loops back to block 420 to select another advertisement, else the display virtual keyboard advertisement component 111 continues at block 460. For example, advertisements 306 may specify a “time out” duration (e.g., 30 seconds, 60 seconds, 5 minutes) so that the advertisements 306 are periodically updated. Accordingly, while a user is typing a message and/or making a gesture the user may be presented with multiple advertisements. In decision block 460, if the virtual keyboard 308 has changed then the display virtual keyboard advertisement component 111 loops back to block 430 to select virtual key(s) for the selected advertisement (e.g., advertisement 306), else the display virtual keyboard advertisement component 111 continues at decision block 470, For example, if the user has shifted to another virtual keyboard with a different layout or a different set of virtual keys, the display virtual keyboard advertisement component 111 will loop back to select key(s) for displaying the advertisement 306. In decision block 470, if the user has interacted with the displayed advertisement 306 (as opposed to the underlying or associated key), then the display virtual keyboard advertisement component 111 continues at block 480 to invoke a user interaction component 112, else the display virtual keyboard advertisement component 111 continues at decision block 490. In decision block 490, if the virtual keyboard 308 is closed, then processing of the display virtual keyboard advertisement component 111 completes, else the display virtual keyboard advertisement component 111 loops back to decision block 450 to determine whether the advertisement 306 has timed out.

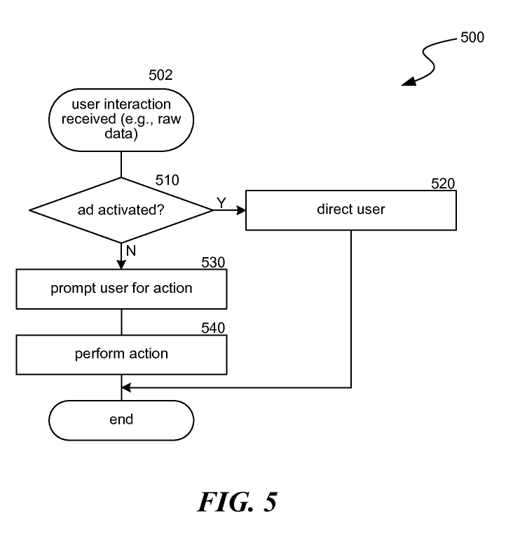

FIG. 5 is a block diagram 500 illustrating an example of a user interaction component 112 in some embodiments. In one or more embodiments, user interaction information is received in block 502. User interaction information, in various embodiments, is one or more raw data, unprocessed data, semi-processed data, processed data, and metadata. In decision block 510, if user interaction is or causes an activation of the advertisement, (e.g., 306) for example, then the user interaction component 112 continues at block 520, else the user interaction component 112 continues at block 530. For example, the user interaction component 112 may be configured to detect certain inputs (e.g., received raw data), actions and/or gestures (e.g., swipe to the right) as an “activation” of an advertisement 306 or an interest to view more information associated with the advertisement 306, and/or other features associated with advertisement 306. In other embodiments, one or more inputs, actions and/or gestures (e.g., swipe to the left) are detected by the user interaction component 112 as non-activation interaction such as a selection of the advertisement 306 but no present interest in following the advertisement 306. In block 520, the user is directed to a local and/or remote media file, for example, or site or location associated with the advertisement 308, such as a website, mobile application, video, audio recording, etc. For example, the user interaction component 112 may display a video over the virtual keyboard or in place of an advertisement 308 displayed with the virtual keyboard 308. As another example, the user interaction component 112 may launch a browser directing the user to the advertiser's 120 website. Alternatively, the user interaction component 112 may initiate a “buy now” command for an advertised product or service, open a shopping cart, initiate a vote or survey response, open a full screen advertisement, and so on. In some examples, the user interaction component 112 may prompt the user to select an action to take with respect to the advertisement 308. In block 530, the user interaction component 112 prompts the user for an action, such as saving the advertisement 308 for later use, forwarding the advertisement to another user, “liking” or sharing the advertisement 308 or advertiser 120 on a social networking site, etc. In block 540, the user interaction component 112 performs an action selected by the user and/or determined by the computing environment 100b and then ends. In various embodiments, other actions are taken in response to a user interaction with an advertisement 308, For example, opening an advertisement 308 in another window, activating an advertisement in a window of a messaging screen, morphing the virtual keyboard 308 to a video or image, claiming a product or prize, ordering or bidding on a good or service, entering a raffle or drawing, printing a coupon, “liking” a TV show, voting for a contestant (e.g., Dancing with the Stars, America's Got Talent, X Factor), reporting ratings for television programs, purchasing a product via a website, such as Groupon, Living Social, etc. and so on. In some cases, an advertisement 308 may be static such that a user interaction with the advertisement 306 is ignored.

The embodiments disclosed herein can be used to display various advertisement types (e.g., logos, text, graphics, images, etc.) or other information (e.g., information about operation of user computing device 110, time, etc.). The advertisement 306 can have one or more inactive areas and one or more active areas (e.g., a button, an activation icon, etc.). A user can contact the inactive area without activating the advertisement 306 and can activate the advertisement 306 by contacting the active area. The advertisements can be displayed continuously or at intervals (e.g., preset intervals, user defined intervals, intervals determined based on user input, etc.). Virtual keyboard 308 can be used to enter characters (e.g., numbers, letters, punctuation, etc.) via a touch screen, for example, Touch screens can display different types of keyboards (e.g., a standard keyboard layout, a customized keyboard layout, etc.) such that a user can contact key images of the displayed keyboard image. A user can touch-type on the displayed keys similar to a physical keyboard.

In some embodiments, the computing environment 100b collects raw data directly from the user via the virtual keyboard 308 and/or other user input. Raw data, in one or more embodiments, is unprocessed or partially processed data that is collected in real-time as each user input is received by the virtual keyboard 308. Raw data, as used by the described technology, provides high-fidelity, accurate information about the user (e.g., about the user's intent, keyword, idea, motive, desire, profile, desired final word, phrase, and/or sentence, etc.) before it is aggregated into its intended, final purpose and/or destination (e.g., the website or program into which the data is inputted.) For example, as a user enters data for posting on a website (e.g., Facebook®, sending to friends (e.g., via Twitter® or email), purchasing a product (e.g., via Amazon®, searching (e.g., via Google®), messaged (e.g., via SMS) and/or other electronic destination), each user input (e.g., text, navigation, selection, biometric, thought, touch, eye movement, gesture, voice command, or other means for a user to manipulate data, via a virtual keyboard 308 of a computing device), in one or more embodiments, is captured (e.g., by the virtual keyboard) as raw data (e.g., data that is the result of a single user input, such as a single key on the virtual keyboard).

As a non-limiting example, a user may want to post online an update of the user's current feeling, location, and/or other user status. The final post may read, for example, “Feeling great today eating ice cream in Pike's Place market”. When the text is completed (e.g., entered into a text input box prior to posting), the user has the option to submit the post (e.g., by selecting a ‘submit’ button). The final post is then uploaded from the user's computing device into the website where it is posted online, for example. The website and user's friends, for example, can each view the final posting in its completed form (i.e., as submitted). Traditional technology stores (e.g., in a data silo) the post in its final form and, in some embodiments, information (e.g., metadata) is gathered by, for example, the website, based on the stored post. For example, the website may determine that the user is in a good mood, likes ice cream, and is in Seattle. From the metadata, the website can target advertisements (or sell the data to third parties who target advertisements) to the user.

In contrast to traditionally technology, in one or more embodiments, the described technology acts upon the raw data prior to the user sending (e.g., submitting) the completed information for posting on the website. For example as the user enters each input of the post, each respective character (i.e., ‘F’, ‘e’, ‘e’ ‘l’ ‘l’ ‘i’ ‘n’ ‘g’ ‘g’ ‘r’ ‘e’ ‘a’ ‘t’ ‘t’ ‘o’ ‘d’ ‘a’ ‘y’ ‘e’ ‘a’ ‘t’ ‘i’ ‘n’ ‘g’ ‘i’ ‘c’ ‘e’ ‘c’ ‘r’ ‘e a’ ‘t’ ‘i’ ‘n’ ‘P’ ‘i’ ‘k’ ‘e’ ‘'’ ‘p’ ‘l’ ‘a’ ‘c’ ‘e’ ‘m’ ‘a’ ‘r’ ‘k’ ‘e’ ‘t’) is captured, via the virtual keyboard 308, and is made available to the computing device and/or sent (e.g., via network packets) to a third party (e.g., a data warehouse, advertiser, etc.) for processing. As described above, each character can be separately captured and processed, however, in some embodiments, the virtual keyboard 308 can make available (e.g., send for further processing) portions of the raw data. For example, the described technology, to reduce network utilization, can send a plurality of characters or words (e.g., “Feel,” “Feeling,” “great,” etc.), instead of separately sending each character. The raw data can be acted upon by, for example, locally generating metadata as each user input is entered, and/or sent to a third party for real-time processing (e.g., creating metadata) for sending targeted advertisements to the user's computing device. As each input is captured by the virtual keyboard 308, higher fidelity, rich data is determined (i.e., generated based on probabilistic functions).

In one or more embodiments, different one or more advertisements are determined (e.g., locally by the virtual keyboard and/or sent over a network to a third party) based on, for example, each typed character of the post. For example, as the user enters each respective raw data ‘F’, ‘e’, ‘e’, ‘I’, each of the raw data is available in real-time for determining targeted advertisements or other information. Additionally and/or alternatively, in some embodiments, the described technology uses predictive text (e.g., predicting a next letter, word, and/or phrase) to more efficiently determine what word, for example, a user is entering on the virtual keyboard.

In some embodiments, in response to receiving raw data (e.g., the ‘Feel’ raw data received in the above example), an emotion-related advertisement is, for example: sent for display to the user; queued pending receipt of additional raw data; used as part of a query (e.g., for referencing a repository of emotional-based advertisements); used for determining higher fidelity advertisements, marketing, polling, searching, etc. (e.g. that the user is feeling ‘great’ and/or that the user is in ‘Seattle’ eating ‘ice cream’); sold; used (locally and/or remotely) for market research, analytics, recommendations, political reasons, etc. and/or other purposes.

Acting on raw data in real-time allows for fast access to pertinent information that can be used for efficient, real-time actions. The more inputs (e.g., characters) received, the higher fidelity the targeted advertisements. For example, to continue the above example, new, additional, and/or modified advertisements can be determined as each character and/or word of the post is entered in the virtual keyboard. Unlike traditional technology, the described technology is configured to determine one or more advertisements without requiring the entire word, phrase, sentence or post to be completed and/or submitted prior to acting on the data.

The above example, was a simple embodiment. Other user inputs, as described above, such as gestures (e.g., swipes at the virtual keyboard), can be additionally and/or alternatively received via the virtual keyboard (308) and acted upon (e.g., locally and/or remotely) for determining real-time, high fidelity advertisements targeted at the user as the user enters each raw data.

In various embodiments, raw data is collected across multiple programs, websites, Apps, searches, etc. that rely on the virtual keyboard (308) for receiving user input data. For example, raw data can be collected from a first destination (e.g., the ‘feeling great’ post describe above, a second destination (e.g., a message sent to the user's daughter, such as asking her to dinner), and a third destination (e.g., a ‘friends’ blog entry about pizza). The described technology captures the raw data, via the virtual keyboard (308), prior to the data being received by the first, second or third destinations, for example. The raw data from each of the three destinations can be processed locally and/or sent to a remote location for further processing. For example, information based on the data sent to each of the three destinations can be inferred, by the technology, that a mother and her daughter may want to eat pizza and, in one or more embodiments, that information can be a basis of further processing (e.g., marketing, advertisements, research, planning, government use, polling, etc.).

Displaying advertisements 308 can be controlled based on type data. For example, computing device(s) 110 can cycle through numerous advertisements while a user composes a text message, an email, interact with a webpage, video or the like. Additionally or alternatively, collected data can be used to more accurately target users with new advertisements based on one or more users' interaction history and can capture analytics across multiple platforms and user computing device(s) 110.

The computing environment 100b in various embodiments, stores, forwards, or otherwise alters advertisements. In one embodiment, an advertisement 306 is stored for later viewing and/or interaction. The advertisement 306 can also be sent (e.g., forwarded) to another user computing device 110 (e.g., another individual's smart phone). The advertisement 306 or associated company can be “liked” on FACEBOOK® or otherwise associated with other websites (e.g., social website), programs, apps, etc.

Virtual keyboards and/or advertisements can be controlled, in some embodiments, based on program settings, operating system settings, or the like. The user and/or computing environment 100b can select a desired language (e.g., English, Spanish, French, Chinese, etc.) to be displayed by, for example, the virtual keyboard (308) and/or advertisement. The virtual keyboard (308) can be integrated into or part of an operating system such that its settings can be modified using the operating system settings. The operating system can select and/or deliver advertisements with cultural relevancy, language relevancy, or the like. User data can also be enhanced by knowing languages used by the user. The user data can be associated with the user's profile and analyzed with other data (e.g., geographic location, demographic information, online activities, search activities, online shopping activities, etc.). The user data can be analyzed based on the settings/profiles and can be used to determine appropriate advertising.

Profiles can also be used to deliver relevant advertisements via the virtual keyboard. A profile can associate one user computing device(s) 110 (e.g., a smartphone, Smart TV, a gaming system such as an Xbox, etc.) with a different user computing device(s) 110 such that either or both user computing device(s) 110 can display an advertisement 306 selected via either user computing device 110. In some embodiments, a profile can associate login information or other user inputted data to the user, or one or more user computing device(s) 110.

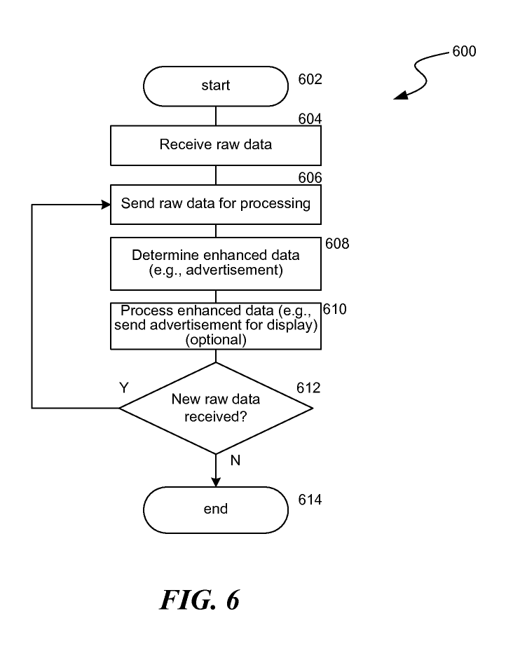

FIG. 6 is a block diagram 600 illustrating the processing of a user interaction component. More specifically, block diagram 600 is one embodiment of the described technology for enhancing the fidelity of data (e.g., for use in determining advertisements, marketing information, polling, etc.) based on iteratively receiving raw data, via a virtual keyboard. Block diagram includes steps 602-614. The flow starts at 602 and, at step 604, the virtual keyboard receives raw data (e.g., from a user operating the virtual keyboard). For example, as the user makes a selection, indication, gesture, enters values, or otherwise interfaces with the virtual keyboard, the resultant raw data is received by the virtual keyboard. As discussed above, each respective user-input can be separately captured and processed, whether destined for a single or multiple programs, Apps, software, servers, etc. At step 606, the raw data is sent for processing. For example, the raw data can be sent to the CPU on the local device or sent, via a network, to a server and, at step 608, the raw data is used to determine high fidelity, rich data (e.g., metadata) that can be used as a basis for determining information targeted to the user, such as advertisements, polling, marketing data, governmental use, etc. At step 610, optionally, the described technology can process (e.g., act upon) the data determined in step 608. For example, if the one or more advertisements were the result of the enhanced data determination step 608, that advertisement can be sent for display (e.g., a screen or the virtual keyboard) to the user, as the user. At step 612, if the user inputting (e.g., typing) new raw data into the virtual keyboard, then flow returns to step 606, where the information is received, used to enhance the raw data previously received (i.e., to increase the accuracy of identifying the user). As described above, the new data received at the virtual keyboard, at step 612, can be destined for the same or a different App, software, program server than the App, software, program and/or server described for step 604. If new raw data is not received at step 612, then the process ends at step 614.

### CONCLUSION

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the described technology provided herein can be applied to other systems, not necessarily the system described herein. The elements and acts of the various embodiments described herein can be combined to provide further embodiments.

These and other changes can be made to the described technology in light of the above Detailed Description. While the above description details certain embodiments of the technology and describes the best mode contemplated, the described technology can be practiced in many ways and with the features disclosed in International PCT Application No. PCT/US2014/010252, which is incorporated by reference in its entirety. The described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

What is claimed is:

1. A computer-implemented method for displaying advertisements, comprising:
receiving one or more advertisements at a device including a display screen;
displaying a virtual keyboard on the display screen;
collecting data from the virtual keyboard; and
determining one or more specific advertisements of the one or more advertisements to be displayed based on the collected data.

2. The computer-implemented method of claim 1, further comprising displaying a targeted advertisement based on data aggregated from the collected data and/or navigating one or more online sources via the virtual keyboard.

3. The computer-implemented method of claim 1, further comprising providing feedback in response to collecting data.

4. A computer-implemented method for displaying advertisements, comprising collecting data from the virtual keyboard displayed by a touchscreen of an electronic device.

5. A computer-readable storage medium storing instructions that, if executed by a computing system, cause the computing system to perform operations for displaying advertisements on a virtual keyboard, comprising:
receiving an indication of a selection of one or more advertisements displayed at a position proximate to one or more keys of a virtual keyboard;
in response to receiving the indication, identifying information associated with the selected one or more advertisements based on input via the virtual keyboard, wherein the information is targeted at a user of the virtual keyboard; and
sending the information for display at the virtual keyboard.

6. A computer-readable storage device storing instructions that, if executed by a computing system, cause the computing system to perform operations for capturing raw data on a virtual keyboard, comprising:
receiving a plurality of raw data at a virtual keyboard, wherein the plurality of raw data is received, via the virtual keyboard, from a user; and
for each one or more of the plurality of raw data received via the virtual keyboard:
sending, via the virtual keyboard, each of the one or more of the plurality of the raw data to determine enhanced data targeted to the user, and
determining enhanced data that is targeted to the user, based on the raw data received by the virtual keyboard,
wherein fidelity of the enhanced data increases to more accurately target the user as each of the one or more plurality of raw data is determined.

7. The computer-readable storage device of claim 6, further comprising sending the increased fidelity data as one or more of an advertisement for display to the user and as information for sale to a purchaser.

8. The computer-readable storage device of claim 7, wherein as the fidelity increases with the determination of each of the one or more plurality of raw data, the advertisement is modified to better reflect an intent of the user.

9. The computer-readable storage device of claim 7, wherein as the fidelity increases with the determination of each of the one or more plurality of raw data, a new advertisement is sent for display to the user, wherein the new advertisement more accurately targets the user.

10. The computer-readable storage device of claim 6, wherein after the plurality of raw data is received at a virtual keyboard, a first one of the plurality of raw data is sent to a first software application and a second one of the plurality of raw data is sent to a second application, wherein each application operates on a device having the virtual keyboard.

11. The computer-readable storage device of claim 10, wherein the first application and the second application reside at a computing device including the virtual keyboard.

12. The computer-readable storage device of claim 6, wherein the raw data is received at the virtual keyboard based on a user input, and wherein the user input is one or more of a touch, gesture, or voice command.

13. The computer-readable storage device of claim 6, wherein the sending, via the virtual keyboard, of each of the one or more of the plurality of the raw data is sent to a processor of a computing device having the virtual keyboard.

14. The computer-readable storage device of claim 6, wherein the sending, via the virtual keyboard, of each of the one or more of the plurality of the raw data is sent, via a network, to a server, and wherein at least a portion of the enhanced data is determined by the server.

15. The computer-readable storage device of claim 6, wherein targeting the user is at least based on a user profile.

16. The computer-readable storage device of claim 6, wherein the enhanced data is metadata, and as the fidelity increases the metadata more accurately reflects an intent of the user.

17. A virtual keyboard data processing device, comprising:
a virtual keyboard;
a processor; and
a memory,
wherein the virtual keyboard is programmed to:
receive a plurality of raw data at the virtual keyboard, wherein the plurality of raw data is received, via the virtual keyboard, from a user;
for each one or more of the plurality of raw data received via the virtual keyboard, determining, by the virtual keyboard, metadata that targets the user, based on the raw data received by the virtual keyboard,
wherein fidelity of the metadata increases to more accurately target the user as each of the one or more plurality of raw data is determined.

18. The virtual keyboard processing device of claim 17, wherein the virtual keyboard is touch sensitive, the raw data is received via the user's touch, and an advertisement is determined for display to the user based on the metadata.

19. A computer-implemented system, comprising:
a means for receiving a plurality of raw data at a virtual keyboard, wherein the plurality of raw data is received, via the virtual keyboard, from a user; and
for each one or more of the plurality of raw data received via the virtual keyboard:
a means for sending, via the virtual keyboard, each of the one or more of the plurality of the raw data to determine enhanced data targeted to the user, and
a means for determining enhanced data that is targeted to the user, based on the raw data received by the virtual keyboard,
wherein fidelity of the enhanced data increases to more accurately target the user as each of the one or more plurality of raw data is determined.

20. The computer-implemented system of claim 19, wherein the means for sending each of the one or more plurality of data is a network interface card.

21. The computer-implemented system of claim 19, wherein the means for sending each of the one or more plurality of data is a processor of a device having the virtual keyboard.
